(19) United States
(12) Patent Application Publication
(10) Pub. No.: US 2007/0251460 A1
(43) Pub. Date: Nov. 1, 2007

(54) Bug guard

(76) Inventor: Debbie J. Olsen, Saginaw, TX (US)

Correspondence Address: JAMES RAY & ASSOCIATES, 2640 PITCAIRN ROAD, MONROEVILLE, PA, 15146, US

(21) Appl. No.: 11/796,298

(22) Filed: Apr. 27, 2007

Related U.S. Application Data
(60) Provisional application No. 60/796,840, filed on May 1, 2006.

(51) Int. Cl. A01K 5/01

(52) U.S. Cl. 119/61.53

(57) ABSTRACT

An apparatus for substantially minimizing an entrance of undesirable insects into an interior portion of one of a home and office building through an opening formed therein. Such apparatus includes an elongated member, having a predetermined length and formed from a first predetermined material, disposed above an opening into an interior portion of such one of such home and office building through such opening formed therein. There is at least one reflective member, having a predetermined shape and formed from a second predetermined material, for deterring such insects from entering such interior portion of such one of such home and office building through such opening formed therein and a mechanism engageable with each of the elongated member and such at least one reflective member for hanging the at least one reflective member on such elongated member.

### CROSS REFERENCE TO RELATED APPLICATION

This patent application is related to and claims priority from U.S. Provisional Patent Application Ser. No. 60/796,840 filed May 1, 2006.

### FIELD OF THE INVENTION

The present invention relates, in general, to methods and apparatus for preventing the undesirable entrance of bugs into the interior of a home and, more particularly, this invention relates to an apparatus which can be hung over an opening of an entrance of a home or office building which will accomplish this function.

### BACKGROUND OF THE INVENTION

Prior to the conception and development of the present invention, as is generally well known in the prior art, flies, mosquitoes and other bugs are pests which enter the inside of a home and office through open screens or doors. These bugs are in most cases unsanitary and in some cases carriers of certain diseases.

There are numerous devices in use which are commonly used to try and keep these bugs out of the home or office. Such devices include but are not limited to fly swatters, fly paper and various insect sprays. In many cases the use of sprays is not a desirable option due to there odor and chemical composition.

### SUMMARY OF THE INVENTION

The present invention provides an apparatus for substantially minimizing an entrance of undesirable insects into an interior portion of one of a home and office building through an opening formed therein. This apparatus comprising an elongated member, having a predetermined length and is formed from a predetermined material, disposed above an opening into the interior portion of such one of such home and office building through such opening formed therein. At least one reflective member, having a predetermined shape and is formed from a second predetermined material, is provided for deterring such insects from entering such interior portion of such one of such home and office building through such opening formed therein. Additionally, there is a means engageable with each of such elongated member and the at least one reflective member for hanging such at least one reflective member on the elongated member.

### OBJECTS OF THE INVENTION

It is, therefore, one of the primary objects of the present invention to provide an apparatus for preventing entrance of undesirable insects into an interior portion of one of a home and office building which is attractive to the eye.

Another object of the present invention is to provide an apparatus for preventing entrance of undesirable insects into an interior portion of one of a home and office building which can be manufactured from a variety of materials and in a variety of shapes and colors.

Still another object of the present invention is to provide an apparatus for preventing entrance of undesirable insects into an interior portion of one of a home and office building which is relatively inexpensive to manufacture.

Yet another object of the present invention is to provide an apparatus for preventing entrance of undesirable insects into an interior portion of one of a home and office building which is easy to install.

An additional object of the present invention is to provide an apparatus for preventing entrance of undesirable insects into an interior portion of one of a home and office building which is environmentally friendly.

An additional object of the present invention is to provide an apparatus for preventing entrance of undesirable insects into an interior portion of one of a home and office building which will reduce the chances for the spread of diseases.

A further object of the present invention is to provide an apparatus for preventing entrance of undesirable insects into an interior portion of one of a home and office building which is more sanitary around food preparation areas.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a plan view of one presently preferred embodiment of the invention;

FIGS. 2 through 10 are plan views of a number of possible shapes for the reflective members formed according to the present invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

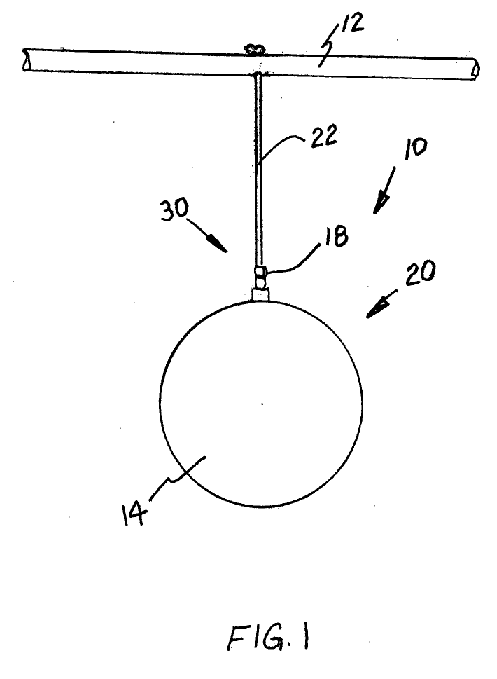

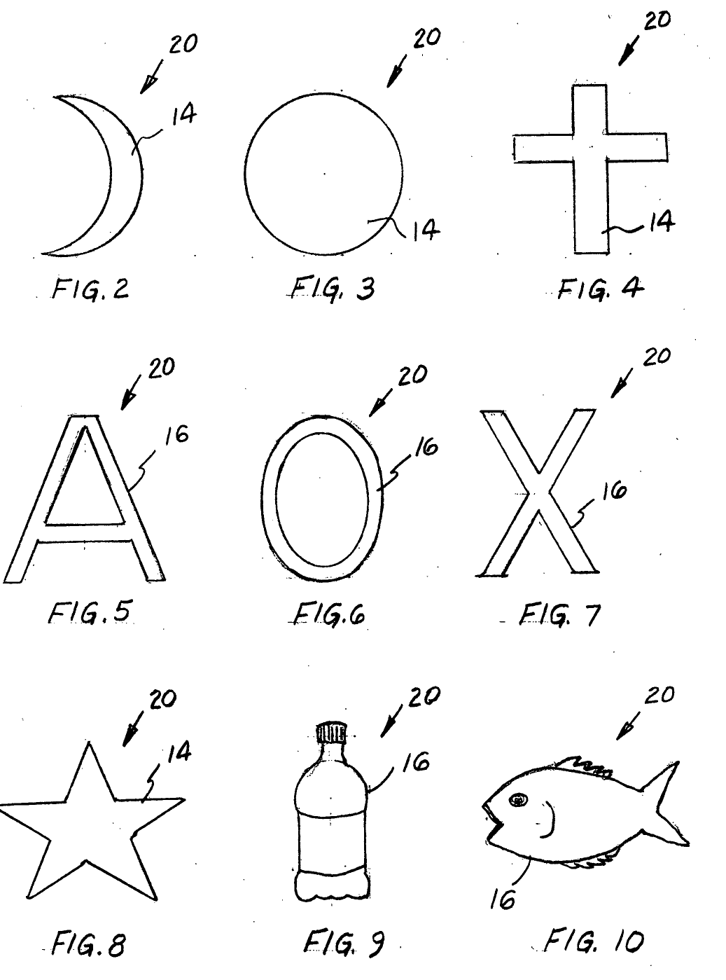

Reference is now made, more particularly, to FIGS. 1-10. Illustrated therein is a presently preferred embodiment of an apparatus, generally designated 10, which will substantially minimize an entrance of undesirable insects into an interior portion of one of a home and office building (not shown) through an opening (not shown) formed therein.

This apparatus 10 includes an elongated member 12. Elongated member 12 has a predetermined length and is formed from a first predetermined material. The elongated member 12 is disposed above the opening into the interior portion of such one of such home and office building.

In the presently preferred embodiment of the invention, the first predetermined material such elongated member 12 is formed from is selected from the group consisting of a fishing line, a string and tubing. Preferably such tubing will be formed from a pre-selected plastic.

There is at least one reflective member, generally designated 20. Such reflective member 20 has a predetermined shape and is formed from a second predetermined material. It has been discovered that this reflective material 20 will deter such insects from entering such interior portion of such one of such home and office building through such opening formed therein.

In the presently preferred embodiment of the invention, the second predetermined material such reflective material 20 is formed from is selected from the group consisting of a silver colored disk, a holographic type material and prismatic materials. Additionally, in this presently preferred embodiment of the invention such predetermined shape of the reflective material 20 will be selected from is the group consisting of pre-selected objects 14, letters 16, numbers (not shown) and animals (not shown).

The final essential element of the present invention is a means, generally designated 30, engageable with each of the elongated member 12 and such at least one reflective member 20 for hanging the at least one reflective member 20 on such elongated member 12.

In the presently preferred embodiment of the invention such means 30 which is engageable with each of such elongated member 12 and the at least one reflective member 20 for hanging the at least one reflective member 20 on the elongated member 12 includes a swivel hook member 18 to prevent wind from twisting the reflective member 20 off such elongated member 12. Additionally, the means 20 that engages each of such elongated member 12 and the at least one reflective member 20 for hanging the at least one reflective member 20 on the elongated member 12 includes a predetermined length of fishing line 22. Preferably, such fishing line 22 is clear.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for substantially minimizing an entrance of undesirable insects into an interior portion of one of a home and office building through an opening formed therein, said apparatus comprising:
(a) an elongated member, having a predetermined length and formed from a first predetermined material, disposed above an opening into an interior portion of such one of such home and office building through such opening formed therein;
(b) at least one reflective member, having a predetermined shape and formed from a second predetermined material, for deterring such insects from entering such interior portion of such one of such home and office building through such opening formed therein; and
(c) a means engageable with each of said elongated member and said at least one reflective member for hanging said at least one reflective member on said elongated member.

2. An apparatus, according to claim 1, wherein said first predetermined material said elongated member is formed from is selected from the group consisting of fishing line, string and plastic tubing.

3. An apparatus, according to claim 1, wherein said second predetermined material said reflective material is formed from is selected from the group consisting of a silver colored disk, a holographic type material and prismatic materials.

4. An apparatus, according to claim 3, wherein said predetermined shape of said reflective material is selected from the group consisting of pre-selected objects, letters, numbers and animals.

5. An apparatus, according to claim 1, wherein said means engageable with each of said elongated member and said at least one reflective member for hanging said at least one reflective member on said elongated member includes a swivel hook member to prevent wind from twisting said reflective member off said elongated member.

6. An apparatus, according to claim 5, wherein said means engageable with each of said elongated member and said at least one reflective member for hanging said at least one reflective member on said elongated member includes a predetermined length of fishing line.

7. An apparatus, according to claim 6, wherein said fishing line is clear.
